(19) United States
(12) Patent Application Publication
(10) Pub. No.: US 2009/0049482 A1
(43) Pub. Date: Feb. 19, 2009

(54) SYSTEM AND METHOD FOR REJOINING RETRANSMISSIONS OF BROADCAST MEDIA

(76) Inventors: Bradford C. Auerbach, Los Angeles, CA (US); Jason B. Kenagy, La Jolla, CA (US)

Correspondence Address: QUALCOMM INCORPORATED, 5775 MOREHOUSE DR., SAN DIEGO, CA, 92121, US

(21) Appl. No.: 11/837,786

(22) Filed: Aug. 13, 2007

(51) Int. Cl. G06F 3/00; H04N 5/445; H04N 7/173

(52) U.S. Cl. 725/58; 725/105; 725/106; 725/39; 725/40

(57) ABSTRACT

Aspects include methods and apparatuses for allowing an electronic device to rejoin a program during a subsequent broadcast of the program. The method may include identifying at least a portion of a first program, the program being broadcast to an electronic device during a first period, identifying a subsequent broadcast of the program during a second period, and outputting notification information related to the subsequent broadcast proximate to the time during the second period during which the identified portion of the program is to be broadcast. Other aspects include systems, apparatus, and devices for accessing broadcast programming and for communicating broadcast programming in ways that allow an electronic device to rejoin a program during a subsequent broadcast of the program.

### TECHNICAL FIELD

This application relates generally to communications, and more specifically, to communication of streamed multimedia data.

### BACKGROUND

Electronic devices such as mobile telephone handsets and other mobile devices may be configured to receive broadcasts of sports, entertainment, or informational multimedia programs. For example, audio and, or video data may be communicated via a broadband broadcast communications link to the electronic devices. Thus, a need exists for methods and apparatuses for providing and viewing broadcast media on such electronic devices.

### SUMMARY

A summary of sample aspects of the disclosure follows. For convenience, one or more aspects of the disclosure may be referred to herein simply as “some aspects.”

Method and apparatuses or devices of the invention each have several aspects, no single one of which is solely responsible for its desirable attributes. Without limiting the scope of this invention, for example, as expressed by the claims which follow, its more prominent features will now be discussed briefly. After considering this discussion, and particularly after reading the section entitled “Detailed Description” one will understand how the features of this invention provide advantages that include allowing an electronic device to rejoin a program during a subsequent broadcast of the program.

One embodiment includes a method of allowing an electronic device to rejoin a program during a subsequent broadcast of the program. The method includes identifying at least a portion of a first program, the program being broadcast to an electronic device during a first period, identifying a subsequent broadcast of the program during a second period, and outputting notification information related to the subsequent broadcast proximate to the time during the second period during which the identified portion of the program is to be broadcast. The method may also include identifying the at least a portion of a first broadcast of the program by automatically identifying the at least a portion in response to receiving a telephone call by a device rendering the first broadcast of the program. Other aspects include systems, apparatus, and devices for accessing broadcast programming and for communicating broadcast programming in ways that allow an electronic device to rejoin a program during a subsequent broadcast of the program.

### BRIEF DESCRIPTION OF THE DRAWINGS

FIG. 1 is a block diagram illustrating an example system for providing broadcast programming to mobile devices.

FIG. 2 is a block diagram illustrating an example of a mobile device such as illustrated in FIG. 1.

FIG. 3 is a flowchart illustrating an example of a method of allowing an electronic device, such as illustrated in FIG. 2, to rejoin a program during a subsequent broadcast of the program such as in the example system illustrated FIG. 1.

FIG. 4 is a flowchart illustrating another example of a method of allowing an electronic device to rejoin a program during a subsequent broadcast of the program such as in the example system illustrated FIG. 1.

FIG. 5 is a flowchart illustrating an example of a method of storing bookmarks on a server or head-end such as in the method illustrated in FIG. 4.

FIG. 6 is a flowchart illustrating an example of a method of storing bookmarks on an electronic device such as in the method illustrated in FIG. 4.

### DETAILED DESCRIPTION

The following detailed description is directed to certain specific aspects of the invention. However, the invention can be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Devices configured to display broadcast media may be configured to perform other functions. Sometimes, functions cannot be performed simultaneously due to, for example, lack of processing capability, a need for conserving battery power, or the inability of the user to perform two tasks at the same time. For example, if the device is rendering a broadcast program when a telephone call is received, the user would usually interrupt watching the multimedia program to answer the phone call. In addition, mobile devices may at times be unable to receive the broadcast signal due to signal degradation. Thus, a user viewing a broadcast program may miss a portion of the program. Where the program is available via multiple broadcasts, the user may be able to search for and identify a subsequent broadcast of the program. However, this can be inconvenient and cumbersome for the user. Further, the user may not remember what was being watched or when the program was interrupted. According to one aspect, a portion, e.g., the missed or interrupted portion, of the program may be identified by the electronic device so that an electronic program guide may be used to identify a subsequent broadcast of the program. The electronic device may notify the user of the subsequent broadcast prior to the broadcast or at about the time of the missed portion of the broadcast. In one embodiment, the electronic program guide is stored on the electronic device and used to identify the subsequent broadcast of the program. In another embodiment, the electronic device communicates the identified (e.g., missed) portion of the program to a server such as a distribution system or other head-end system that identifies a subsequent broadcast and provides notification for the user.

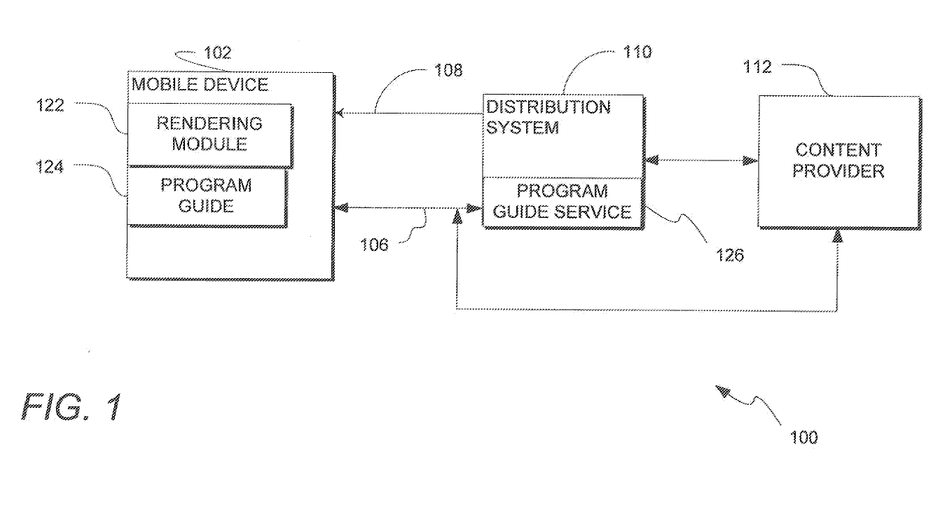

FIG. 1 is a block diagram illustrating an example system 100 for providing broadcast programming to mobile devices 102 from one or more content providers 112 via a distribution system 110. While a single mobile device 102 is shown in FIG. 1, examples of the system 100 may be configured to use any number of mobile devices 102. The system 100 also includes a distribution system 110 and a content provider 112. The distribution system 110 may receive data representing a multimedia program from the content provider 112. The multimedia programs may be communicated over a wired or wireless program communication link 108. In one embodiment, the communications link 108 is a high speed or broadband link. In one embodiment, the content provider 112 may communicate the content directly to the mobile device 102 (not shown in FIG. 1), bypassing the distribution system 110, via the same or a different communications link. It is to be recognized that in other embodiments multiple content providers 112 may provide programs via multiple distribution systems 110 to the mobile devices 102.

In the example system 100 of FIG. 1, the program communication link 108 is illustrated as a unidirectional network. However, the program communication link 108 may also be a fully symmetric bi-directional network. The program communication link 108 may comprise one or more wired and/or wireless links, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1×EV-DO or 1×EV-DO Gold Multicast) system, an IEEE 802.11 system, a MediaFLO system, a DMB system, an orthogonal frequency division multiple access (OFDM) system, or a DVB-H system.

In the example system 100, the mobile device 102 is also configured to communicate on a second communication link 106. In one embodiment, the second communication link 106 is a two way communication link in the example system 100, however, the link 106 may also comprise a second link from the mobile device 102 to the distribution system 110 and/or the content provider 112. The second communication link 106 may also be a wireless network configured to communicate voice traffic and/or data traffic. The communication link 106 may communicate program guide and other data between the distribution system 110 and the mobile device 102.

The mobile device 102 includes a rendering module 122 configured to render the multimedia programming received over the program communication link 108. The rendering module 122 may include analog and/or digital technologies. The rendering module 122 may include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage.

In addition to communicating programming content to the mobile device 102, the distribution system 110 may also include a program guide service 126. The program guide service 126 receives program schedule and content related data from the content provider 112 and/or other sources and communicates data representing defining an electronic programming guide (EPG) 124 to the mobile device 102. The EPG 124 may include data related to the broadcast schedule of multiple programs available to be received over the program communication link 108. The EPG data may include titles of programs, start and end times, category classification of programs (e.g., sports, movies, comedy, etc.), quality ratings, adult content ratings, etc. The EPG 124 may also be communicated to the mobile device 102 over the program communication link 108 and stored in the mobile device 102.

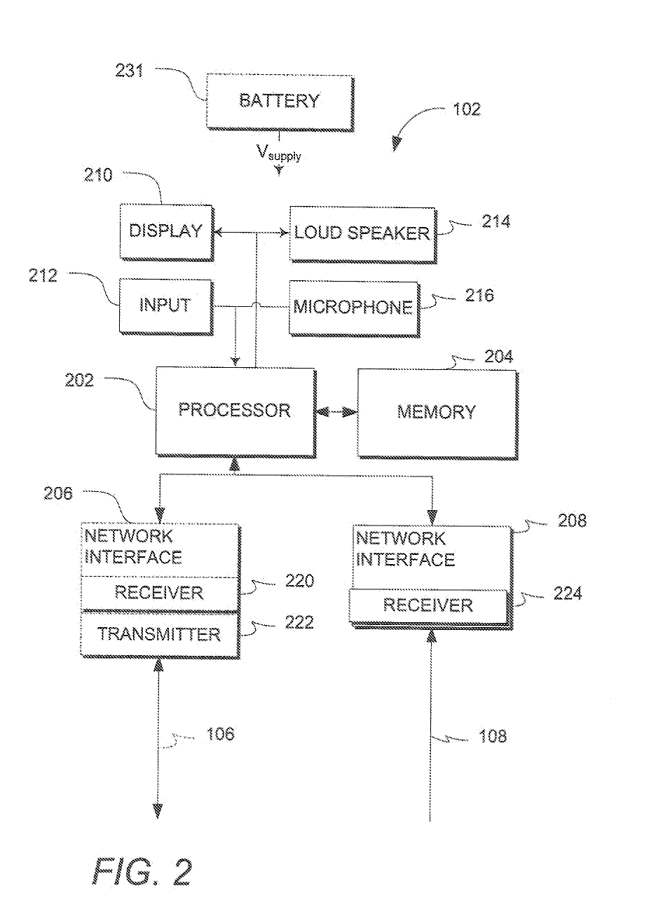

FIG. 2 is a block diagram illustrating an example of the mobile device 102 such as illustrated in FIG. 1. The device 102 includes a processor 202 that is in communication with a memory 204 and a network interface 208 that communicates over the program communication link 108. The network interface 208 includes a receiver 224 configured to receive the unidirectional program communication link 108. The network interface 208 and receiver 224 may receive signals according to wired technologies including Ethernet, telephone (e.g., POTS), cable, power-line, and fiber optic systems, and/or wireless technologies comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1×EV-DO or 1×EV-DO Gold Multicast) system, an IEEE 802.11 system, a MediaFLO system, a DMB system, an orthogonal frequency division multiple access (OFDM) system, or a DVB-H system.

The mobile device 102 may include an optional second network interface 206 for communicating via the second bi-directional communication link 106. The network interface 206 may include any suitable antenna (not shown), a receiver 220, and a transmitter 222 so that the exemplary device 102 can communicate with one or more devices over the second communication link 106. Optionally, the network interface 206 may also have processing capabilities to reduce processing requirements of the processor 202.

The device 102 also includes one or more of a display 210, a user input device 212 such as a key, touch screen, or other suitable tactile input device, a loudspeaker 214 comprising a transducer adapted to provide audible output based on a signal received over the communication link 106 and/or a microphone 216 comprising a transducer adapted to provide audible input of a signal that may be transmitted over one or both of the communication links 106 and 108.

The device 102 may optionally include a battery 231 to provide power to one or more components of the device 102. The device 102 may comprise at least one of a mobile handset, a personal digital assistant, a laptop computer, a headset, a vehicle hands free device, or any other electronic device. For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, or any other suitable device.

The components described herein may be implemented in a variety of ways. Referring to FIG. 2, the device or apparatus 102 is represented as a series of interrelated functional blocks that may represent functions implemented by, for example the processor 202, software, some combination thereof, or in some other manner as taught herein. For example, the processor 202 may facilitate user input via the input devices 212. Further, the transmitter 222 may comprise a processor for transmitting that provides various functionalities relating to transmitting information to another device 102. The receiver 220 may comprise a processor for receiving that provides various functionality relating to receiving information from another device 102.

The device 102 may be configured to receive data concurrently from one or both of the communication links 106 and 108. For example, the processor 202 may be incapable of performing the receiving and/or transmitting functions of the bidirectional network interface 206 at the same time that the broadband unidirectional interface 208 is receiving over the program communication link 108. Thus, for example, in one embodiment, reception or display of a broadcast of a program may be discontinued over the program communication link 108 when a signal, e.g., a telephone call for example, is received over the communication link 106.

As noted above, FIG. 2 illustrates that in some aspects these components may be implemented via appropriate processor components. These processor components may in some aspects be implemented, at least in part, using structure as taught herein. In some aspects, a processor may be adapted to implement a portion or all of the functionality of one or more of these components. In some aspects one or more of the components represented by dashed boxes are optional.

In some aspects, the device or apparatus 102 may comprise an integrated circuit. Thus, the integrated circuit may comprise one or more processors that provide the functionality of the processor components illustrated in FIG. 2. For example, in some aspects a single processor may implement the functionality of the illustrated processor components, while in other aspects more than one processor may implement the functionality of the illustrated processor components. In addition, in some aspects the integrated circuit may comprise other types of components that implement some or all of the functionality of the illustrated processor components.

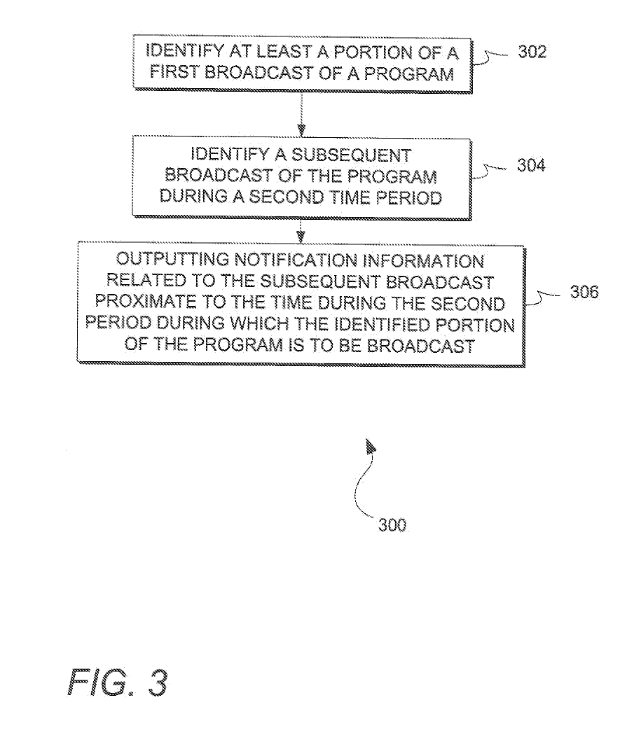

FIG. 3 is a flowchart illustrating an example of a method 300 of allowing an electronic device to rejoin a program during a subsequent broadcast of the program such as in the example system 100. The acts or events associated with the method 300 may be performed by different types of devices in the system 100. For example, the acts or events of the method 300 may be performed by a server such as the distribution system 110, may be performed by the mobile device 102, or may be performed in part by the mobile device 102 and in part by distribution system 110 and/or the content provider system 112.

The method 300 is performed while an electronic device, the mobile device 102, for example, is receiving a broadcast program over the program communication link 108. When it is determined that the electronic device has terminated receiving the program, at least a portion of the broadcast program that was being received is identified at block 302. The portion being identified may be the portion at a specified elapsed time from the start of the program. The portion being identified may be a scene sequence number, a frame number, or some other piece of data identifying a temporal location in the program sequence where the program was terminated. The identifying information may also include a program identifier such as a title, serial number, or other form of data used to identify the program that was being received.

In some examples, the functions performed at block 302 may be performed by the processor 202 of the mobile device 102. In these examples, the processor 202 may receive a signal, e.g., from the network interface 208, indicative that the program is no longer being received. Knowing when the program started, using data from an EPG for example, the processor 202 can determine the elapsed time of the program.

In other examples, the functions performed at block 302 may be performed by a processor (not shown) of the distribution system 110, and/or the content provider system 112. In these examples, the processor performing the functions may monitor one of the communication links 106 or 108 for a signal from the electronic device indicative that the user is receiving the program. The absence of the signal may be used by the processor to determine that the program could no longer be received due to signal interruption. Alternatively, the processor may monitor one of the communication links 106 or 108 for a signal indicating that the electronic device has terminated receiving the program and subsequently perform the functions of the block 302.

Proceeding to block 304, a subsequent broadcast of the program is identified. By using the data identifying the program (e.g., a title, or serial number) that was determined at block 302, an EPG may be used to identify when the program is going to be rebroadcast. This may be done by simply correlating the data obtained at the block 302 with similar data stored in the EPG. Multiple instances of the program may also be identified. The functions performed at the block 304 may be performed by the processor 202 of the mobile device 102, or by a processor on the distribution system 110 or the content provider system 112.

In one embodiment, the processor 102 automatically identifies a subsequent broadcast based on available broadcasts of the program. In addition, the broadcast may be identified based on other available information such as the schedule or calendar of one or more users of the device 200, and/or viewing time preferences of such users. For example, users may identify time periods during which they prefer to view broadcasts or during which they prefer not to view broadcasts.

In one embodiment, after termination of the first broadcast of the program, a processor 202, e.g., using the display 210, may provide a menu or other user interface having options for a user to identify a subsequent broadcast. For example, in one embodiment, the processor 202 may identify the subsequent broadcasts and provide the user with a menu or other user interface from which to identify a particular subsequent broadcast. In one embodiment, this menu is provided immediately after termination, or after completion of the phone call or another task that terminated the broadcast. In one embodiment, the menu is provided to the user at any later time, e.g., after the processor 102 has correlated the program with the EPG.

At block 306, notification information regarding the subsequent broadcast is output at a time proximate the retransmission of the portion of the program identified at the block 302. The information may be output at a predetermined time prior to the retransmission of the identified portion. For example, the notification may be a few minutes, e.g., 1-15 minutes, a few hours, days, or any other time period prior to the broadcast of the identified portion of the program. In one embodiment, this time period is based on a user preference setting, e.g., a default setting, or a setting for the particular bookmark. The outputting at block 306 may include transmitting a signal from the distribution system 110 or the content provider 112 to the mobile device 102 over one of the communication links 106 or 108. Outputting may also include the processor 202 of the mobile device 102 providing an alert signal to the user of the electronic device, e.g., via a user interface. For example, the alert signal may include a text or graphical message displayed on the display 210, an audible message played over the loudspeaker 214 or any combination of the two. In one embodiment, the mobile device 102 may automatically tune to the subsequent broadcast and begin playing the subsequent broadcast of the program at a time proximate to the identified portion of the program.

In one embodiment, after termination of the first broadcast of the program, a processor 202, e.g., using the display 210, may provide a menu or other user interface of options for a user to select how to notify the user. For example, in one embodiment, the options include notifying the user at a specified time prior to the subsequent broadcast, automatically tuning to the subsequent broadcast at the start of the subsequent broadcast, automatically tuning to the subsequent broadcast proximate to the identified portion of the broadcast, or any other suitable notification option. In one embodiment, this menu is provided immediately or after completion of the phone call or other task that interrupted reception of the broadcast. In one embodiment, the menu is provided to the user at any later time, e.g., after the processor 102 has correlated the program with the EPG and allowed the user to select a subsequent broadcast. In one embodiment, the processor 202 automatically configures the notification based on specified user preferences that may be edited by the user, e.g., at any time.

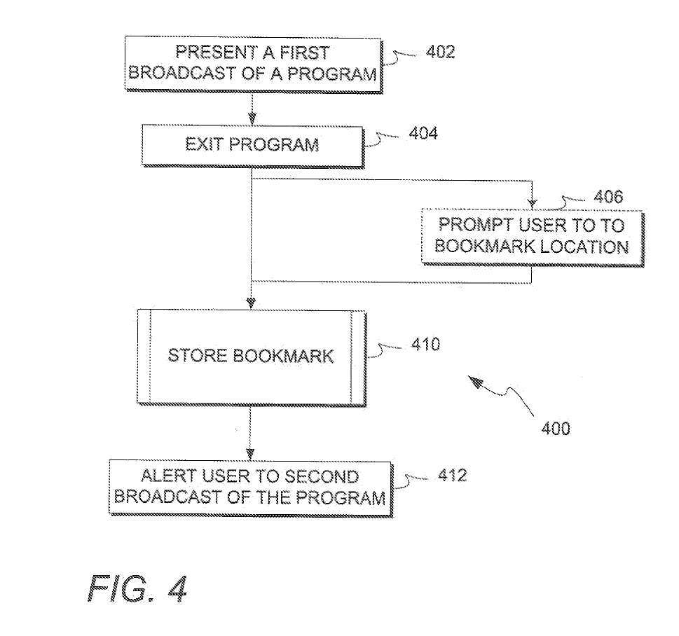

FIG. 4 is a flowchart illustrating another example of a method 400 of allowing an electronic device to rejoin a program during a subsequent broadcast of the program such as in the example system 100. At block 402, a first broadcast of a program is being received by the receiver 224 and presented to the user on the display 210 of the electronic device 102. At some point in time, e.g., an elapsed time into the broadcast of the program, program reception is terminated and exited at block 404. Termination may be due to loss of the signal being received by the receiver 224. Termination may be due to an input by the user or by the user turning the device off. Termination may also be automatically performed when an incoming or outgoing phone call is initiated in cases where the electronic device is also a communication device.

Upon termination of the program at the block 404, the method 400 proceeds to block 410, where the processor 202 stores a bookmark in the memory 204 of the mobile device 102. The bookmark contains information identifying at least the portion of the program that was being displayed when the broadcast was terminated, such as that determined at the block 302 of the method 300 discussed above.

Optionally, upon termination of the program at the block 404, the method 400 may proceed to block 406 where the user is prompted to indicate whether they want to store the bookmark information. If the user chooses to store the bookmark, the method 300 proceeds to the block 410 and proceeds as discussed above. If the user does not want to store the bookmark, the method 300 is exited.

The bookmark information may also include information identifying the subsequent rebroadcast of the program, such as discussed above in reference to the block 304 of the method 300. When the subsequent broadcast is identified, e.g., using data contained in an EPG for example, the method 400 proceeds to block 412 where the user is alerted as to the proximate time that the portion of the program identified by the stored bookmark is being rebroadcast. The bookmark storing functions performed at the block 410 may be performed by the mobile device 102 or by another device such as the distribution system 110 or from the content provider system 112. The user may be alerted by receiving a message over one of the communication links 106 or 108 from the distribution service 110 or the content provider 112. This message may be an actual alert at a time proximate to the subsequent broadcast or a message that instructs the mobile device 102 to present the alert at the appropriate time. In addition, generating of the alert may be controlled by the processor 202 of the mobile device 102. Details of two examples of the bookmark storing functions performed at the block 410 will now be discussed.

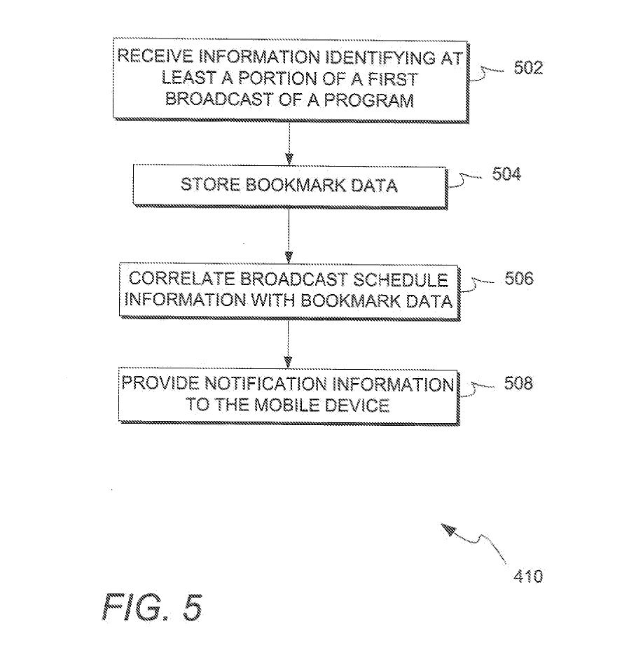

FIG. 5 is a flowchart illustrating in more detail an example of a method of storing bookmarks at the block 410 of the method 400 on a server such as the distribution system 110. At block 502, the mobile device 102 communicates bookmark data to the distribution system 110. The bookmark data may comprise at least a portion of the broadcast of the program, e.g., information identifying the temporal location within the program when the program was interrupted. The bookmark data may be generated at the mobile device 102 and transmitted to the distribution system 110 over a communication link such as the link 106 upon exiting the program. Alternatively, an indication that the mobile device 102 exited the program may be sent to the distribution system 110 from the mobile device 102 and the distribution system 110 may generate the bookmark data. Alternatively, the distribution system 110 may detect that the mobile device 102 is no longer receiving the program (e.g., by detecting that the mobile device 102 has left the network or is no longer registered on the network) and respond by generating the bookmark data.

Next, at a block 504, the distribution system 110 stores the bookmark data. The bookmark data can be stored in any of various memories including RAM memory, flash memory, ROM memory, EPROM memory, EEPROM memory, registers, hard disk, a removable disk, a CD-ROM, or any other form of storage medium known in the art.

Moving to a block 506, the distribution system 110 correlates the broadcast schedule information with the stored bookmark data in order to identify a subsequent rebroadcast of the program identified by the bookmark data. The broadcast schedule information may identified based on data stored in an EPG. The correlation may involve searching for a matching title, an identification number or any other form of data that can be used to identify a specific program. The correlation may also be based at least partly on non-EPG data that may narrow the search. For example, the search may be limited to a category that the program represented by the bookmark data falls into such as, for example, sports, movies, cartoons, comedy, etc.

Proceeding to a block 508, the distribution system 110 provides notification information related to the subsequent broadcast proximate to the second period during which the identified portion of the program is to be broadcast. This notification information may be provided directly to the mobile device 102 via one of the communication links 106 or 108 in the form of the alert performed at the block 412 of the method 400 as discussed above. Alternatively, the notification information may be stored on the distribution system 110, for example, in a mailbox, to allow the mobile device 102 to obtain it at a latertime. The notification information may be provided at a specified time interval prior to the subsequent broadcast of the specified portion of the program identified by the bookmark data. The notification information may also be provided upon receiving EPG data, e.g., receiving an updated EPG containing the instance of the subsequent broadcast. Other suitable ways of providing the notification information to the mobile device 102 may be used at the block 508. After the notification information is provided at the block 508, the method 400 may proceed to the block 412.

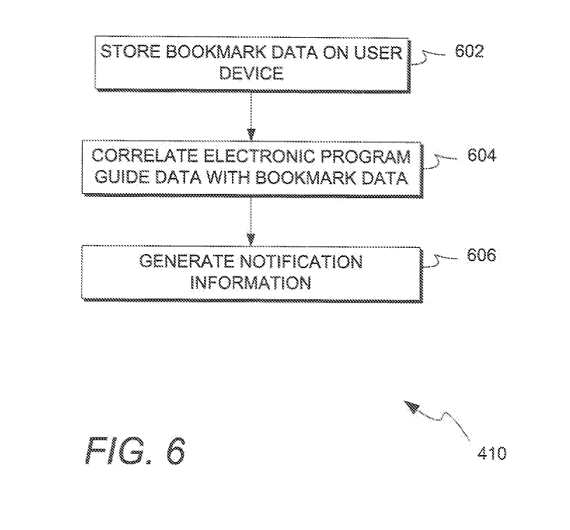

FIG. 6 is a flowchart illustrating an example of a method of storing bookmarks on the mobile device 102 such as at the block 410 in the method 400 illustrated in FIG. 4. In this example of the block 410, the bookmark data is stored onto the memory 204 of the mobile device 102 that was receiving the broadcast program that was interrupted. The bookmark data can be stored in any of various memories including RAM memory, flash memory, ROM memory, EPROM memory, EEPROM memory, registers, hard disk, a removable disk, a CD-ROM, or any other form of storage medium known in the art.

Proceeding to block 604, the processor 202 of the mobile device 102 correlates the stored bookmark data with EPG data containing a schedule of future program broadcasts. Correlation methods such as those discussed above in reference to the block 506 may be used at the block 604.

Next at a block 606, the processor 202 generates notification information. The notification information contains data related to the subsequent broadcast of the program proximate to the time during the second period when the identified portion of the program is to be broadcast. The notification information can be stored in the memory 204 of the mobile device 102 and the user of the mobile device can be alerted at the block 412 of the method 400 discussed above. The notification information may, for example, comprise a reminder in a calendar or a reminder associated with the program guide. The notification information may be stored until the time proximate to the subsequent broadcast of the program, at which time a signal may be generated to alert the user. In one embodiment, the device 102 may automatically begin accessing or playing subsequent broadcast at the time proximate to the broadcast.

Those skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In view of the above, one will appreciate that the disclosure addresses how to allow a mobile device to rejoin a program during a subsequent broadcast if the program. For example, the illustrated aspects provide a method and apparatus for accessing a subsequent broadcast of a program at a time proximate to the time that a first program was stopped. Also, the illustrated aspects provide a method and apparatus communicating broadcasts to one or more mobile devices and allowing the mobile device to rejoin a subsequent rebroadcast of the program.

Any illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those skilled in the art will recognize that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of allowing an electronic device to rejoin a program during a subsequent broadcast of the program, comprising:
identifying at least a portion of a first program, the program being broadcast to an electronic device during a first period;
identifying a subsequent broadcast of the program during a second period; and
outputting notification information related to the subsequent broadcast proximate to the time during the second period during which the identified portion of the program is to be broadcast.

2. The method of claim 1, wherein identifying the at least a portion of a first broadcast of the program comprises:
rendering the first broadcast of the program; and
receiving an input indicative of the at least a portion of the first broadcast of the program.

3. The method of claim 1, wherein identifying the at least a portion of a first broadcast of the program comprises automatically identifying the at least a portion in response to receiving a telephone call by a device rendering the first broadcast of the program.

4. The method of claim 1, wherein the at least a portion of the first broadcast of the program comprises a temporal location in the program.

5. The method of claim 4, wherein the temporal location comprises an elapsed time.

6. The method of claim 1, further comprising storing data indicative of the identified portion of the program.

7. The method of claim 1, wherein identifying the subsequent broadcast comprises identifying the subsequent broadcast based on data defining a program guide.

8. The method of claim 1, further comprising rendering the subsequent broadcast starting at about the identified portion.

9. The method of claim 1, further comprising receiving the subsequent broadcast starting at about the identified portion.

10. The method of claim 9, wherein receiving the subsequent broadcast comprises receiving a wireless signal indicative of the subsequent broadcast.

11. The method of claim 1, wherein outputting the notification information comprises outputting the notification information at a specified time interval prior to the specified portion of the program.

12. The method of claim 1, wherein outputting the notification information comprises storing data indicative of at least one instance for outputting the notification information in response to receiving electronic program guide data.

13. The method of claim 12, wherein outputting the notification information further comprises notifying the electronic device by reference to the stored data.

14. The method of claim 1, wherein outputting the notification information comprises transmitting the notification information to the electronic device.

15. The method of claim 1, wherein outputting the notification information comprises displaying the notification information on a display of the electronic device.

16. An apparatus for accessing broadcast programs, comprising:
a receiver configured to receive broadcasts of a program; and
a processor configured to:
identify at least a portion of a first program, the program being broadcast to an electronic device during a first period;
identify a subsequent broadcast of the program during a second period; and
output notification information related to the subsequent broadcast proximate to the time during the second period during which the identified portion of the program is to be broadcast.

17. The apparatus of claim 16, wherein the processor is further configured to:
render the first broadcast of the program; and
receive an input indicative of the at least a portion of the first broadcast of the program.

18. The apparatus of claim 17, wherein the apparatus further comprises:
a transceiver configured to receive telephone calls,
wherein the processor is further configured to automatically identify the at least a portion in response to the transceiver receiving a telephone call.

19. The apparatus of claim 17, wherein the at least a portion of the first broadcast of the program comprises a temporal location in the program.

20. The apparatus of claim 19, wherein the temporal location comprises an elapsed time.

21. The apparatus of claim 17, further comprising a storage configured to store data indicative of the identified portion of the program.

22. The apparatus of claim 17, wherein the processor is configured to identify the subsequent broadcast based on data defining a program guide.

23. The apparatus of claim 17, wherein the processor is further configured to render the subsequent broadcast starting at about the identified portion.

24. The apparatus of claim 23, wherein the processor is further configured to render the subsequent broadcast starting at about the identified portion.

25. The apparatus of claim 17, wherein the receiver is configured to receive the subsequent broadcast starting at about the identified portion.

26. The apparatus of claim 17, wherein the receiver is configured to receive a wireless signal indicative of the subsequent broadcast.

27. The apparatus of claim 17, wherein the processor is configured to output an alert of the subsequent broadcast at a specified time interval prior to the specified portion of the program.

28. The apparatus of claim 17, further comprising a storage, wherein the receiver is configured to receive program guide data and the processor is configured to store to the storage data indicative of at least one instance to output an alert of the subsequent broadcast in response to receiving the electronic program guide data.

29. The apparatus of claim 28, wherein the processor is configured to output the alert based on the stored data.

30. The apparatus of claim 28, further comprising a display, wherein the processor is configured to output the notification information to the display.

31. An apparatus for providing data for allowing an electronic device to rejoin a program during a subsequent broadcast of the program, comprising:
a memory configured to store a schedule of broadcasts; and
a processor configured to:
receive information identifying at least a portion of a first broadcast of a program received by the electronic device in a first time period;
identify a subsequent broadcast of the program during a second time period based on the schedule; and
provide to the electronic device notification information of the subsequent broadcast prior to the second period during which the identified portion of the program is to be broadcast.

32. The apparatus of claim 31, wherein the at least a portion of the first broadcast of the program comprises a temporal location in the program.

33. The apparatus of claim 32, wherein the temporal location comprises an elapsed time.

34. The apparatus of claim 31, wherein the memory is configured to store data indicative of the identified portion of the program.

35. The apparatus of claim 31, wherein the schedule of broadcasts defines a program guide.

36. The apparatus of claim 31, wherein the processor is configured to correlate the schedule of broadcasts with the information identifying the at least a portion of the first broadcast of the program.

37. The apparatus of claim 31, wherein the transceiver is configured to proved the subsequent broadcast via a wireless network.

38. The apparatus of claim 31, wherein the processor is configured to provide the notification information at a specified time interval prior to the specified portion of the program.

39. An apparatus, comprising:
means for storing a schedule of broadcasts; and
means for processing configured to:
receive information identifying at least a portion of a first broadcast of a program received by the electronic device in a first time period;
identify a subsequent broadcast of the program during a second time period based on the schedule; and
provide to the electronic device notification information of the subsequent broadcast prior to the second period during which the identified portion of the program is to be broadcast.
